(19) United States
(12) Patent Application Publication
(10) Pub. No.: US 2018/0009492 A1
(43) Pub. Date: Jan. 11, 2018

(54) METHOD FOR MANUFACTURING SHUTTER DEVICE FOR VEHICLE

(71) Applicant: SHIROKI CORPORATION, Fujisawa-shi (JP)

(72) Inventors: Shinya WATANABE, Fujisawa-shi, Kanagawa (JP); Kenji YAMAMOTO, Fujisawa-shi, Kanagawa (JP); Kazuya YOKOYAMA, Fujisawa-shi, Kanagawa (JP)

(73) Assignee: Shiroki Corporation, Fujisawa-shi (JP)

(21) Appl. No.: 15/545,260

(22) PCT Filed: Dec. 22, 2015
(86) PCT No.: PCT/JP2015/085831

§ 371 Date: Jul. 20, 2017

(30) Foreign Application Priority Data
Jan. 26, 2015 (JP) 2015-012339

(51) Int. Cl. B62D 65/04; B60K 11/08

(52) U.S. Cl. CPC B62D 65/04; B60K 11/085

(57) ABSTRACT

Provided is a shutter device for a vehicle, in which a manufacturing cost is reduced.

A method of manufacturing a shutter device (1) for a vehicle, which adjusts an amount of air flowing from an outside of a vehicle surface to an inside thereof, includes steps of: preparing an upper base (11), a lower base (12), and a pillar (13) independently from one another; and mounting an upper portion of the pillar (13) on the upper base (11), mounting a lower portion of the pillar (13) on the lower base (12), and thereby assembling a frame member (10).

### TECHNICAL FIELD

The present invention relates to a method of manufacturing a shutter device for a vehicle.

### BACKGROUND ART

A shutter device for a vehicle is described in Patent Literature 1. The shutter device for the vehicle is mounted on a front portion of the vehicle. The shutter device for the vehicle is provided with a frame member that defining a rectangular opening, and fins that are provided inside the opening and are pivotably supported on the frame member. A flow rate of air guided into an engine room is changed by controlling postures of the fins, and fuel efficiency or the like can be improved.

### CITATION LIST

### Patent Literature

[Patent Literature 1]: Japanese Unexamined Patent Application Publication No. 2012-35829

### SUMMARY OF THE INVENTION

### Technical Problem

Meanwhile, the frame member of the shutter device for the vehicle described in Patent Literature 1 is formed by integral molding of a resin. Therefore, a metal mold for forming the frame member becomes bigger, and a manufacturing cost is increased.

Accordingly, the present invention is directed to providing a method of manufacturing a shutter device for a vehicle, capable of reducing a manufacturing cost.

### Solution to Problem

A method of manufacturing a shutter device for a vehicle is a method manufacturing a shutter device for the vehicle, which adjusts an amount of air flowing from an outside of a vehicle surface to an inside thereof and includes: a frame member having an opening provided therein and mounted on the vehicle; a fin extending in a first direction; and a rotary shaft unit configured to pivotally support the fin on the frame member to be pivotable in the opening of the frame member, wherein the frame member includes an upper base that extends in the first direction, a lower base that is provided below the upper base and extends in the first direction, and at least one pillar that extends in a direction intersecting the first direction and is connected to the upper base and the lower base, the method including:

preparing the upper base, the lower base, and the pillar, which are independently from one another; and

mounting an upper portion of the pillar on the upper base and mounting a lower portion of the pillar on the lower base, to assemble the frame member.

According to the method of manufacturing the shutter device for the vehicle according to the present invention, the upper base, the lower base, and the pillar, which are independently from one another, are combined to assemble the frame member.

In the above-described method of manufacturing the shutter device for the vehicle according to the present invention, the method may include:

forming an upper long member having a uniform sectional shape in a longitudinal direction;

forming a lower long member having a uniform sectional shape in the longitudinal direction;

cutting the upper long member at a necessary length and obtaining the upper base having a uniform sectional shape in the longitudinal direction; and

cutting the lower long member at a necessary length and obtaining the lower base having a uniform sectional shape in the longitudinal direction.

There is a case where a size of the frame member of the shutter device for the vehicle is different according to a type of vehicle to be mounted. In this case, the upper base and the lower base, which have different lengths, are required. According to the prevent manufacturing method, it is able to form the upper base having different lengths by cutting the upper long member at a necessary length, and it is able to form the lower base having different lengths by cutting the lower long member at a necessary length. Even when a size of the frame member of the shutter device for the vehicle is different, it is able to form the upper base and the lower base by the common metal mold, it is possible to reduce the manufacturing cost.

In the above-described method of manufacturing the shutter device for the vehicle according to the present invention, the method may include:

forming an engaging part having a uniform sectional shape in a longitudinal direction, in the forming the upper long member or the lower long member having the uniform sectional shape in the longitudinal direction; and

engaging an engaged part of the pillar with the engaging part.

According to the prevent manufacturing method, by engaging an engaged part with the engaging part, the assembling of the upper base and the pillar or the assembling of the lower base and the pillar becomes easy.

In the above-described method of manufacturing the shutter device for the vehicle according to the present invention, the method may include:

providing an upper positioning part for setting a mounting position of the pillar for the upper long member or the upper base;

providing a lower positioning part for setting the mounting position of the pillar for the lower long member or the lower base;

positioning the pillar with respect to the upper base using the upper positioning part and mounting the pillar on the upper base; and

positioning the pillar with respect to the lower base using the lower positioning part and mounting the pillar on the lower base.

According to this manufacturing method, the upper base and the pillar, and the lower base and the pillar can be accurately and simply assembled using the upper positioning part and the lower positioning part.

### Advantageous Effects of the Invention

According to the present invention, a method of manufacturing a shutter device for a vehicle, in which a manufacturing cost is reduced, is provided.

### BRIEF DESCRIPTION OF THE DRAWINGS

FIG. 1 is a perspective view of a shutter device according to an embodiment of the present invention.

FIG. 2 is a perspective view illustrating a fin and bearings.

FIG. 3 is a view illustrating a frame member.

FIG. 4 is a view illustrating an upper base.

FIG. 5 is a view illustrating a lower base.

FIG. 6 is a view illustrating a left pillar.

FIG. 7 is a view illustrating a coupling part of the upper base and the left pillar.

FIG. 8 is a view illustrating a coupling part of the lower base and the left pillar.

FIG. 9 is a view illustrating a middle pillar.

FIG. 10 is a view illustrating a coupling part of the lower base and the middle pillar.

### DESCRIPTION OF EMBODIMENTS

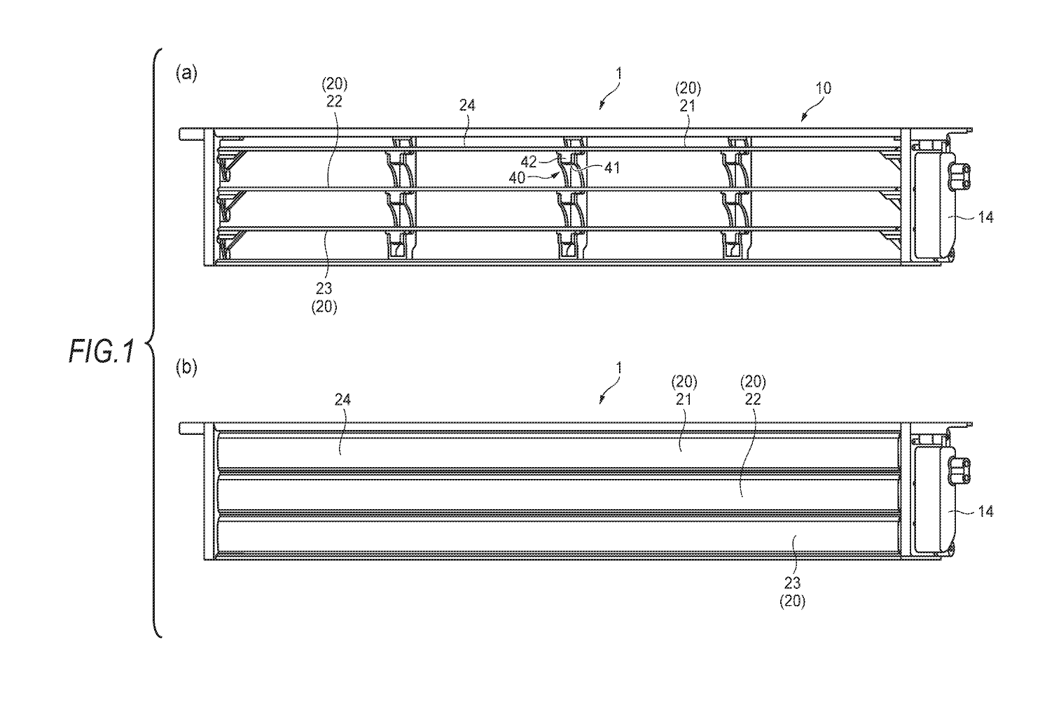

Hereinafter, a shutter device 1 for a vehicle according to an embodiment of the present invention will be described in detail with reference to the drawings. FIG. 1 is a front view of the shutter device 1 for a vehicle according to the present embodiment. FIG. 1(a) illustrates the shutter device 1 for the vehicle in an opened state, and FIG. 1(b) illustrates the shutter device 1 for the vehicle in a closed state.

The shutter device 1 for the vehicle is provided at a front lower portion of the vehicle, and is able to introduce air from the outside of a vehicle surface into the inside (for example an engine room). The shutter device 1 for the vehicle can adjust an amount of the air flowing into the engine room. As illustrated in FIG. 1, the shutter device 1 for the vehicle is provided with a frame member 10, fins 20, and rotary shaft units 40 that rotatably support the fins 20 on the frame member 10. The fins 20 are driven and rotated by a motor 14.

The three fins 20 are pivotably provided inside the opening of the frame member 10. The fins 20 are long wide members extending in a first direction. In the present embodiment, the first direction is equal to the left-and-right direction. The fins 20 are wide members that are integrally molded from a resin. In the following description, wide surfaces of the fins 20 are referred to as principal planes 24.

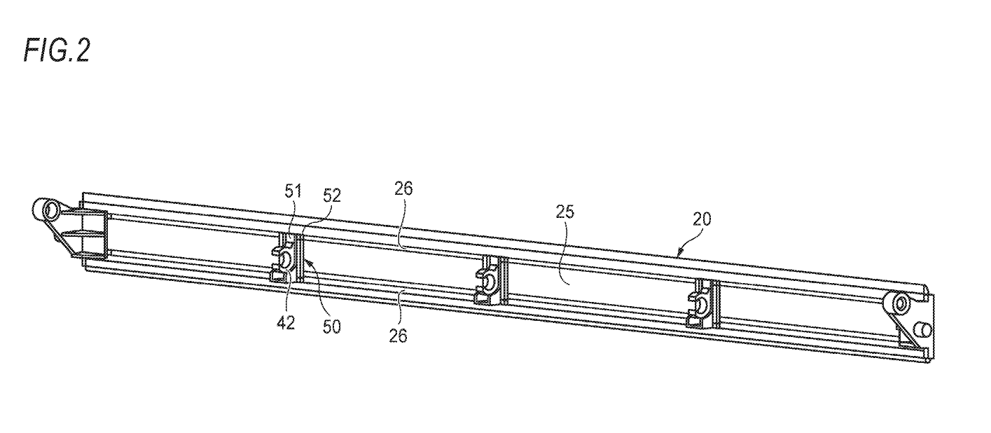

The rotary shaft unit 40 is provided with a rotary shaft 41 and a bearing 42 that rotatably supports the rotary shaft 41. In the present embodiment, the rotary shaft 41 is provided to the frame member 10, and the bearing 42 is provided to a bearing unit 50 (see FIG. 2) mounted on the fin 20. The rotary shaft 41 has an approximately cylindrical shape, and a long axis thereof extends in the first direction. The rotary shaft 41 can pivot around a pivot axis extending in the first direction. Thereby, the fin 20 is supported on the frame member 10 to be rotatable about the pivot axis extending in the first direction. A sectional shape of the rotary shaft unit 41 may be set as, for instance, a shape that is partly cut out from an approximately circular shape, an approximately elliptical shape, a circular shape, or an elliptical shape.

The fins 20 are pivotably supported on the frame member 10 via the rotary shaft units 40. The fins 20 can pivot around the pivot axes extending in the first direction. The three fins 20 are caused to pivot around the pivot axis extending in the first direction, and thereby can change an opened state and a closed state.

FIG. 1(a) illustrates the shutter device 1 for the vehicle in the opened state. In this state, the principal planes 24 of the fins 20 are directed approximately upward. In this state, the fins 20 are separated from each other, so that a gap occurs between the fins 20 as viewed from the front. In this state, air is introduced from the gap between the fins 20, and is guided into the engine room.

FIG. 1(b) illustrates the shutter device 1 for the vehicle in the closed state. In this state, the principal planes 24 of the fins 20 are directed approximately forward. In this state, at least part of an upper end of the middle fin 22 provided at a center in the up-and-down direction is in contact with a lower end of the upper fin 21, which is located above the middle fin 22 in the up-and-down direction. At least part of a lower end of the middle fin 22 is in contact with an upper end of the lower fin 23, which is located below the middle fin 22 in the up-and-down direction. A lower end of the lower fin 23 is in contact with the lower base 12. Thereby, the opening of the frame member 10 is closed by the fins 20, and the amount of air flowing into the engine room is blocked.

FIG. 2 is a perspective view illustrating the fin 20 and the bearings 42 mounted on the fin 20. As illustrated in FIG. 2, the fin 20 is provided with a rear surface 25 being the opposite side of the principal plane 24. The bearing unit 50 having the bearing 42 is mounted on the rear surface 25 of the fin 20. The bearing unit 50 is provided with a plate-like main body 51, and the bearing 42 that is provided on the main body 51. The bearing 42 can pivotally support the rotary shaft 41 provided on the frame member 10. The fin 20 has a uniform sectional shape in the first direction. Grooves 26 extending in a longitudinal direction are provided in the rear surface 25 of the fin 20. Protrusions 52 provided on the bearing unit 50 are fitted into the grooves 26, thereby fixing the bearing unit 50 to the fin 20.

<Details of Frame Member>

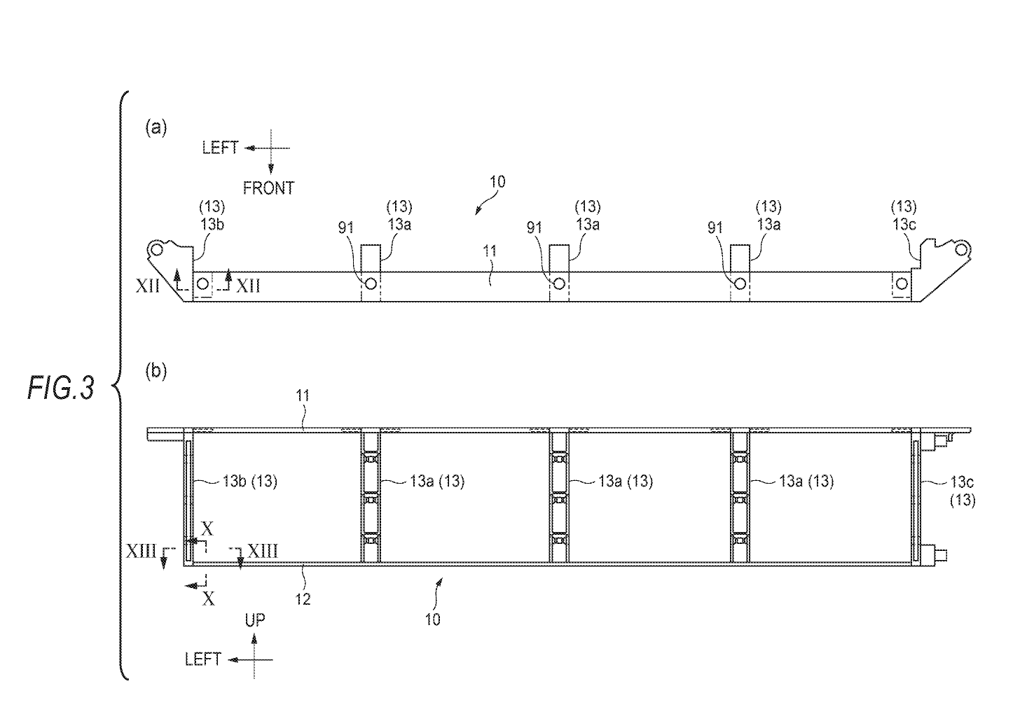

Next, the frame member 10 will be described in detail using FIGS. 3 to 10.

FIG. 3 is a view illustrating the frame member 10. FIG. 3(a) is a top view of the frame member 10, and FIG. 3(b) is a front view thereof. As illustrated in FIG. 3, the frame member 10 is provided with an upper base 11, a lower base 12, and at least two (five in the present embodiment) pillars 13. The pillars 13 are connected to the upper base 11 and the lower base 12.

The upper base 11 of the frame member 10 is a long plate-like member extending in the left-and-right direction. The lower base 12 is also a long plate-like member extending in the left-and-right direction. The lower base 12 is located below the upper base 11. In the present embodiment, the lower base 12 is different in shape from the upper base 11, but it may have the same shape as the upper base 11.

In the present embodiment, the pillars 13 include a right pillar 13c that is located at a right end in a front view, a left pillar 13b that is located at a left end in the front view, and three intermediate pillars 13a that are located between the right pillar 13c and the left pillar 13b. The three intermediate pillars 13a are members identical to one another. Besides the fact that a motor 14 is mounted at the right side of the right pillar 13c (see FIG. 1), the right pillar 13c and the left pillar 13b are horizontally symmetrical members. A rectangular opening in the front view is defined by the upper base 11, the right pillar 13c, the left pillar 13b, and the lower base 12.

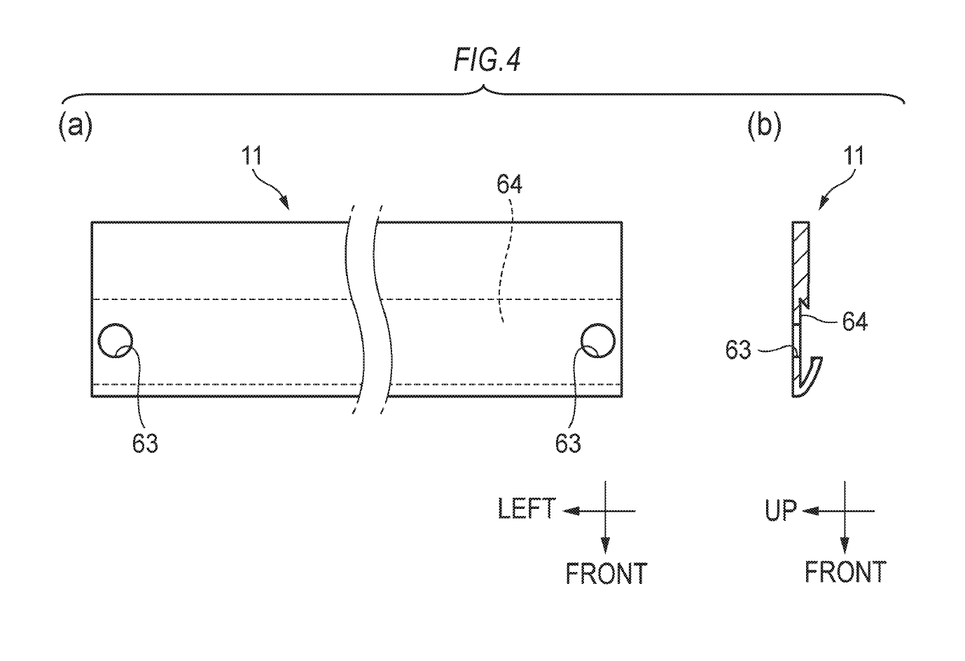

FIG. 4 is a view illustrating the upper base 11. FIG. 4(a) is a top view of the upper base 11, and FIG. 4(b) is a sectional view thereof. As illustrated in FIG. 4, the upper base 11 is a long plate-like member. A groove 64 is provided in a lower surface of the upper base 11, is open to the lower surface, and extends in a longitudinal direction. A sectional shape of the groove 64 is wider at a bottom side than the opening. First through-holes 63 are provided adjacent to both ends of the upper base 11 in the longitudinal direction.

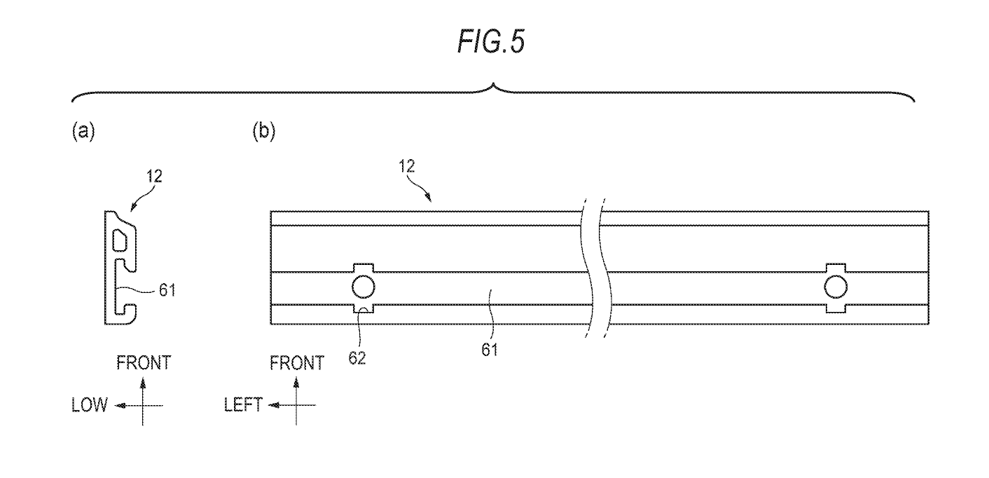

FIG. 5 is a view illustrating the lower base 12. FIG. 5(a) is a sectional view of the lower base 12, and FIG. 5(b) is a top view thereof. As illustrated in FIG. 5, the lower base 12 is a long plate-like member. A groove 61 is provided in an upper surface of the lower base 12, is open to the upper surface, and extends in a longitudinal direction. Concave parts 62 wider than the other region in the longitudinal direction are provided on the groove 61 in the vicinity of both ends in the longitudinal direction. A sectional shape of the groove 61 is wider at a bottom side than the opening.

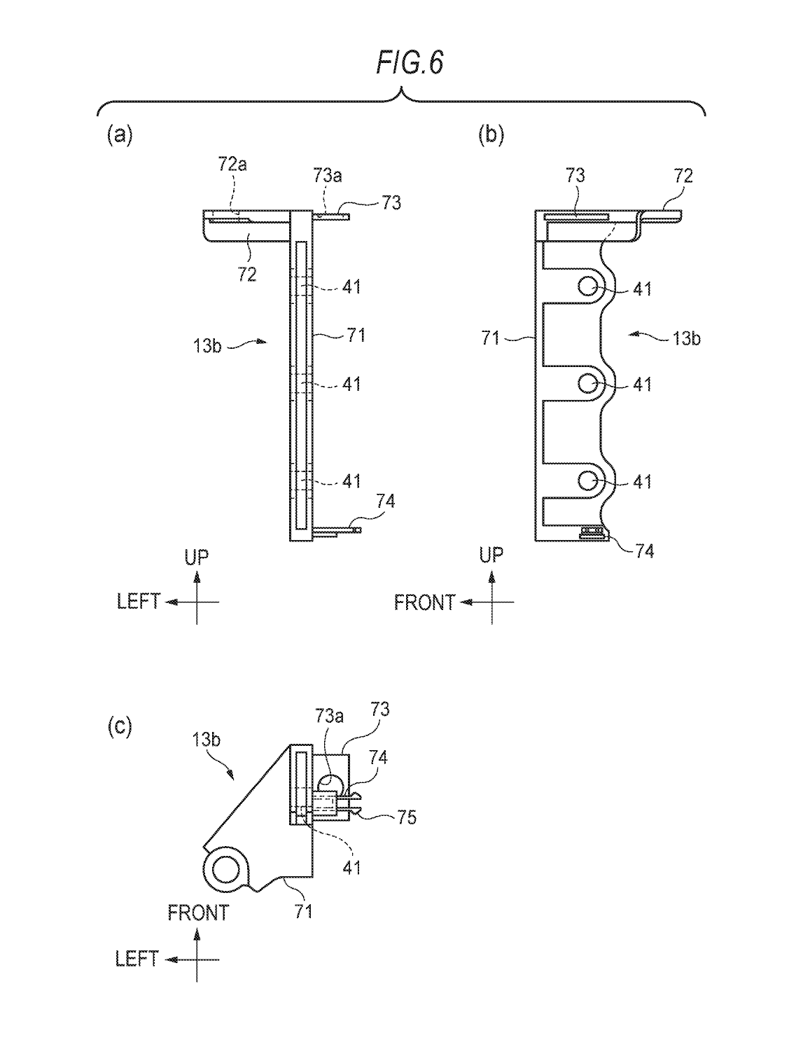

FIG. 6 is a view illustrating the left pillar 13b. FIG. 6(a) is a top view of the left pillar 13b, FIG. 6(b) is a right side view thereof, and FIG. 6(c) is a bottom view thereof. The right pillar 13c has a shape that is an approximately horizontally symmetrical with the left pillar 13b, and so description thereof will be omitted.

As illustrated in FIG. 6, the left pillar 13b is provided with a pillar-shaped main body 71 extending in an up-and-down direction, three rotary shafts 41 provided on the main body 71, a vehicle body mounting part 72 protruding leftward from an upper portion of the main body 71, a first mounting part 73 protruding rightward from the upper portion of the main body 71, and a second mounting part 74 protruding rightward from a lower portion of the main body 71. A width of the first mounting part 73 in a front and rear direction is identical to that of the groove 64 of the upper base 11 in the front and rear direction. A bolt is inserted into a through-hole 72a provided in the vehicle body mounting part 72, and whereby the shutter device 1 for the vehicle is mounted on the vehicle. The first mounting part 73 is mounted on a left end of the upper base 11. The second mounting part 74 is mounted on a left end of the lower base 12.

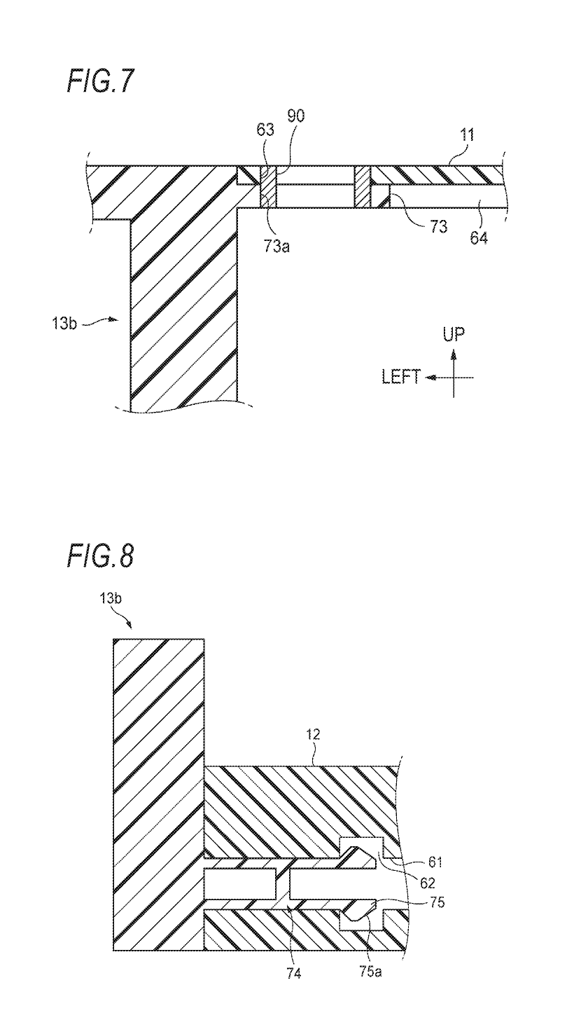

FIG. 7 is a view illustrating a coupling part of the upper base 11 and the left pillar 13b. FIG. 7 illustrates a cross section taken along line XII-XII in FIG. 3(a). As illustrated in FIG. 7, the first mounting part 73 of the left pillar 13b is fitted into the groove 64 of the upper base 11. A second through-hole 73a having the same diameter as the first through-hole 63 of the upper base 11 is provided in the first mounting part 73 of the left pillar 13b. A columnar fastener 90 formed of a metal is fitted into the first through-hole 63 of the upper base 11 and the second through-hole 73a of the left pillar 13b, and whereby the left pillar 13b is fixed to the upper base 11.

Although not illustrated, the right pillar 13c is fixed to the upper base 11 by the same structure.

FIG. 8 is a view illustrating a coupling part of the lower base 12 and the left pillar 13b. FIG. 8 illustrates a cross section taken along line XIII-XIII in FIG. 3(b). As illustrated in FIG. 8, the second mounting part 74 of the left pillar 13b has a claw part 75 protruding rightward. A tip of the claw part 75 is bifurcated to be bendable in the front and rear direction. Protrusions 75a protruding in the front and rear direction are provided at the tip of the claw part 75. The claw part 75 is inserted into the groove 61 of the lower base 12. The protrusions 75a of the tip of the claw part 75 are fitted into the concave parts 62 of the groove 61, and the left pillar 13b is fixed to the lower base 12.

Although not illustrated, the right pillar 13c is fixed to the lower base 12 by the same structure.

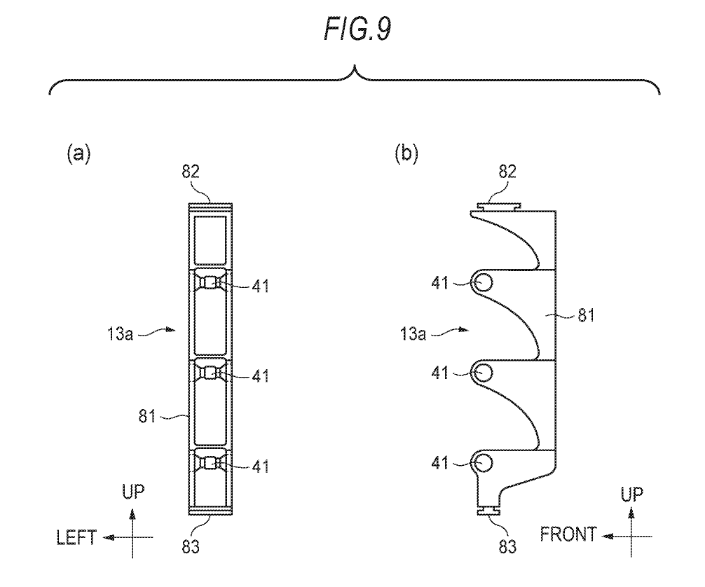

FIG. 9 a view illustrating the intermediate pillar 13a. FIG. 9(a) is a front view of the intermediate pillar 13a, and FIG. 9(b) is a side view thereof. As illustrated in FIG. 9, the intermediate pillar 13a is provided with a pillar-shaped main body 81 extending in the up-and-down direction, three rotary shafts 41 provided on the main body 81, an upper convex part 82 provided at an upper portion of the main body 81, and a lower convex part 83 provided at a lower portion of the main body 81. The intermediate pillar 13a is fixed to be not movable relative to the upper base 11 by a fastening bolt 91 (see FIG. 3(a)) that passes through and is inserted into the upper base 11. A sectional shape of the upper convex part 82 is nearly identical to that of the groove 64 of the upper base 11. A sectional shape of the lower convex part 83 is nearly identical to that of the groove 61 of the lower base 12.

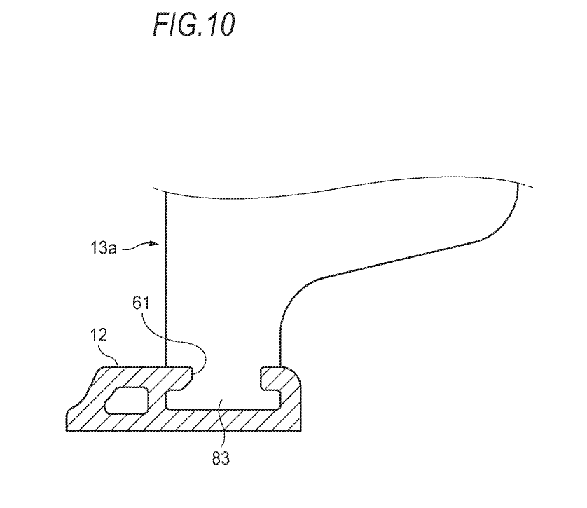

FIG. 10 is a view illustrating a coupling part of the lower base 12 and the intermediate pillar 13a. FIG. 10 illustrates a cross section taken along line X-X in FIG. 3(b). As illustrated in FIG. 10, the lower convex part 83 of the intermediate pillar 13a is fitted into the groove 61 of the lower base 12. Due to the fitting of the lower convex part 83 of the intermediate pillar 13a and the groove 61 of the lower base 12, the intermediate pillar 13a is positioned with respect to the lower base 12 in the front and rear direction, and is regulated in movement in the front and rear direction.

Although not illustrated, similarly, the upper convex part 82 of the intermediate pillar 13a is fitted into the groove 64 of the upper base 11, is positioned with respect to the upper base 11 in the front and rear direction, and is regulated in movement in the front and rear direction.

<Method of Manufacturing Shutter Device 1 for the Vehicle>

Next, a method of manufacturing the shutter device 1 for the vehicle will be described.

First, the upper base 11, the lower base 12, and the pillar 13 are prepared independently from one another. Each of the upper base 11, the lower base 12, and the pillar 13 can be formed by resin molding. For example, the pillar 13 can be formed by injection molding.

The upper base 11 and the lower base 12 are preferably produced according to the following process.

First, upper and lower long members, each of which has a uniform sectional shape in a longitudinal direction, are formed by extrusion molding. A sectional shape of the upper long member is identical to that of the upper base 11 shown in FIG. 4(b), and a sectional shape of the lower long member is identical to that of the lower base 12 shown in FIG. 5(a).

In this process, the groove 64 (an example of the engaging part) of the upper base 11 is formed in the upper long member, and the groove 61 (an example of the engaging part) of the lower base 12 is formed in the lower long member. Further, the upper long member is cut at a required length of the upper base 11, and the lower long member is cut at a required length of the lower base 12. The first through-holes 63 are processed adjacent to both ends of the cut upper long member in a longitudinal direction. The concave parts 62 are formed by cutting in the vicinity of both ends of the cut lower long member in the longitudinal direction. Thereby, the upper base 11 and the lower base 12 can be obtained.

When the sectional shapes of the upper base 11 and the lower base 12 are identical to each other, a common long member may be produced for the upper base 11 and the lower base 12, and be cut to obtain the upper base 11 and the lower base 12. Since there is no need to prepare different metal molds for the upper long member and the lower long member, a manufacturing cost can be reduced.

Next, the upper portion of the pillar 13 is mounted on the upper base 11, and the lower portion of the pillar 13 is mounted on the lower base 12, so that the frame member 10 is assembled. To be more specific, the intermediate pillars 13a are moved relative to the upper base 11 and the lower base 12 in a longitudinal direction, so that the upper convex parts 82 (the engaged parts) of the intermediate pillars 13a are inserted into the groove 64 (the engaging part) of the upper base 11, and the lower convex part 83 of the intermediate pillars 13a are inserted into the groove 61 of the lower base 12. The intermediate pillars 13a are fixed to the upper base 11 by the fastening bolts 91 at desired positions in the longitudinal direction.

Further, the left pillar 13b is caused to approach the upper base 11 and the lower base 12 from the left side, the first mounting part 73 of the left pillar 13b is fitted into the groove 64 of the upper base 11, and the claw part 75 of the second mounting part 74 of the left pillar 13b is fitted into the concave part 62 of the groove 61 of the lower base 12. Thereby, the left pillar 13b is temporarily attached to the upper base 11 and the lower base 12. Further, in this state, the fastener 90 formed of a metal is fitted into the first through-hole 63 of the upper base 11 and the second through-hole 73a of the first mounting part 73 of the left pillar 13b. Thereby, the upper base 11, the lower base 12, and the left pillar 13b are fixed. According to the same procedures, the right pillar 13c is fixed to the upper base 11 and the lower base 12.

In this way, the frame member 10 is assembled. Further, the bearings 42 of the fins 20 are fitted into the rotary shafts 41 provided on the frame member 10, so that the fins 20 are mounted on the frame member 10.

### Effects

In this way, according to the method of manufacturing the shutter device 1 for the vehicle of the present embodiment, since the metal mold for forming the frame member 10 does not become bigger, the manufacturing cost is easily reduced. That is, as in Patent Literature 1, when the entire frame member is injection-molded at a time, the metal mold for forming the frame member becomes bigger. However, according to the manufacturing method of the present embodiment, since the metal mold has only to be prepared for each of the parts of the upper base 11, the lower base 12, and the pillar 13, the metal mold does not become bigger, and the manufacturing cost can be reduced.

Meanwhile, a size or a shape of the frame member required depending on a vehicle or a type of vehicle on which the shutter device 1 for the vehicle is mounted may be different. In this case, there is a need to prepare the metal mold for molding each part for each type of vehicle.

However, the method of manufacturing the shutter device 1 for the vehicle according to the present embodiment has a process of forming the long member having a uniform sectional shape in the longitudinal direction, and a process of cutting the long member at a necessary length and obtaining the upper and lower bases 11 and 12 having a uniform sectional shape in the longitudinal direction.

Therefore, the long member is cut at a necessary length, and whereby the upper base 11 having a different length and the lower base 12 having a different length can be simply produced. For example, when the long member is produced by extrusion molding, there is no need to prepare a different metal mold for each type of vehicle, and the long member can be produced using a common metal mold. Thus, the manufacturing cost can be further reduced. When the upper base 11 and the lower base 12 have the same sectional shape, the upper base 11 and the lower base 12 can be produced by a common metal mold, and thus the manufacturing cost can be further reduced.

According to the method of manufacturing the shutter device 1 for the vehicle of the present embodiment, the process of forming the long member having a uniform sectional shape in the longitudinal direction has a process of forming the grooves 61 and 64 (the engaging parts), each of which has a uniform sectional shape in the longitudinal direction, engaging the upper convex parts 82 (the engaged part) of the intermediate pillars 13a with the groove 64 of the upper base 11, and engaging the lower convex parts 83 (the engaged part) of the intermediate pillars 13a with the groove 61 of the lower base 12. Due to a simple work of engaging the engaging part and the engaged part, temporary assembly can be performed by positioning the intermediate pillars 13a to the upper base 11 and the lower base 12. Therefore, a task of fixing the intermediate pillars 13a to the upper base 11 using the fastening bolts 91 after that is easily done, and the assembly of the upper base 11, the lower base 12, and the pillars 13 is facilitated.

In the above embodiment, the example in which the groove 61 is also simultaneously formed when the long member is formed has been described. However, after the long member having no fitting parts is formed, the fitting parts may be formed by, for instance, cutting.

The method of manufacturing the shutter device 1 for the vehicle may include a process of:

providing an upper positioning part for setting mounting positions of the pillars 13 for the upper long member or the upper base 11;

providing a lower positioning part for setting the mounting positions of the pillars 13 for the lower long member or the lower base 12;

positioning the pillars 13 with respect to the upper base 11 using the upper positioning part and mounting the pillars 13 on the upper base 11; and

positioning the pillars 13 with respect to the lower base 12 using the lower positioning part and mounting the pillars 13 on the lower base 12.

For example, marks may be put on positions at which the pillars 13 are mounted in the longitudinal direction of the long member, and the intermediate pillars 13a may be positioned in the longitudinal direction using the marks. According to this manufacturing method, the task of mounting the intermediate pillars 13a on the upper base 11 and the lower base 12 can be done in an accurate and simple way.

In the process of injection-molding the long member, the marks may be formed along with the long member, and the marks may be formed by post-processing after the long member is obtained by extrusion molding.

In the above embodiment, the example in which the plurality of bearing units 50 having the same shape are used has been described. However, a plurality of bearing units in which a distance between the fin 20 and the center of the bearing 42 that is a pivot axis of the fin 20 is different may be used. For example, an interval between the fin 20 and the pivot axis of the rotary shaft unit 40 in the middle in a left-and-right direction (an example of the first direction) may be greater than that between the fin 20 and the pivot axis of the rotary shaft unit 40 at both ends in the left-and-right direction. Thus, a shutter device for a vehicle having a shape in which the middle in the left-and-right direction protrudes forward is obtained.

In the aforementioned embodiment, the example in which, regarding the rotary shaft unit, the rotary shaft is provided on the frame member and the bearing unit including the bearing is mounted on the fin has been described, but the present invention is not limited thereto. A configuration in which the bearing is provided on the frame member and the rotary shaft is provided on the fin may be adopted.

In the aforementioned embodiment, the example in which the first direction is identical to the left-and-right direction has been described, but the present invention is not limited thereto. The first direction may be identical to the up-and-down direction, or extend in a direction inclined with respect to the left-and-right direction or the up-and-down direction.

In the aforementioned embodiment, the example in which the fins are supported by each of the pillars has been described, but the present invention is not limited thereto. For example, the fins may be supported only by the pillars at the both ends in the left-and-right direction. Alternatively, the fins may be supported by one or more pillars in the middle in the left-and-right direction.

The structure for fixing the bearing units 50 to the fin 20 is not limited to the protrusions 52 of the bearing units 50 and the grooves 26 of the fin 20. The grooves may be provided in the bearing unit, and the protrusions may be provided on the fin. Alternatively, without being limited to a combination of the groove and the protrusion, a structure for mutually fitting the groove and the protrusion may be adopted.

In the aforementioned embodiment, the bearing units 50 mounted on the rear surface 25 of the fin 20 have been described, but the present invention is not limited thereto. For example, the bearing units 50 may be bearing units having the shapes of the caps that are fixed to the fin by covering from the first direction the both ends of the fin in the first direction. In this case, since there is no need to provide the grooves 26 or the like in the fin 20, the shape of the fin 20 can be simplified.

In the aforementioned embodiment, the example in which the first direction is identical to the left-and-right direction has been described, but the present invention is not limited thereto. The first direction may be identical to the up-and-down direction, or extend in the direction inclined with respect to the left-and-right direction or the up-and-down direction.

This application is based on Japanese Patent Application No. 2015-012339, filed on Jan. 26, 2015, the contents of which are incorporated herein by reference.

### INDUSTRIAL APPLICABILITY

According to the present invention, the method of manufacturing the shutter device for the vehicle in which the manufacturing cost is reduced is provided.

### REFERENCE SIGNS LIST

1: Shutter device for vehicle
10: Frame member
11: Upper base
12: Lower base
13: Pillar
13a: Intermediate pillar
13b: Left pillar
13c: Right pillar
14: Motor
20: Fin
21: Upper fin
22: Middle fin
23: Lower fin
24: Principal plane
25: Rear surface
40: Rotary shaft unit
41: Rotary shaft
42: Bearing
50: Bearing unit
51: Main body
61: Groove
62: Concave part
63: First through-hole
64: Groove
71: Main body
72: Vehicle body mounting part
72a: Through-hole
73: First mounting part
73a: Second through-hole
74: Second mounting part
75: Claw part
75a: Nose
81: Main body
82: Upper convex part
83: Lower convex part
90: Fastener
91: Fastening bolt

1. A method of manufacturing a shutter device for a vehicle, which adjusts an amount of air flowing from an outside of a vehicle surface to an inside thereof and includes:
a frame member having an opening provided therein and mounted on the vehicle;
a fin extending in a first direction; and
a rotary shaft unit configured to pivotally support the fin on the frame member to be pivotable in the opening of the frame member, wherein
the frame member includes
an upper base that extends in the first direction,
a lower base that is provided below the upper base and extends in the first direction, and
at least one pillar that extends in a direction intersecting the first direction and is connected to the upper base and the lower base, and
the method comprising:
preparing the upper base, the lower base, and the pillar independently from one another; and
mounting an upper portion of the pillar on the upper base, mounting a lower portion of the pillar on the lower base to assemble the frame member.

2. The method of manufacturing the shutter device for the vehicle according to claim 1, further comprising:
forming an upper long member having a uniform sectional shape in a longitudinal direction;
forming a lower long member having a uniform sectional shape in the longitudinal direction;
cutting the upper long member at a necessary length and obtaining the upper base having a uniform sectional shape in the longitudinal direction; and
cutting the lower long member at a necessary length and obtaining the lower base having a uniform sectional shape in the longitudinal direction.

3. The method of manufacturing the shutter device for the vehicle according to claim 2, comprising:
forming an engaging part having a uniform sectional shape in a longitudinal direction, in the forming the upper long member or the lower long member having the uniform sectional shape in the longitudinal direction; and
engaging an engaged part of the pillar with the engaging part.

4. The method of manufacturing the shutter device for the vehicle according to claim 2, comprising:
providing an upper positioning part for setting a mounting position of the pillar for the upper long member or the upper base;
providing a lower positioning part for setting the mounting position of the pillar for the lower long member or the lower base;
positioning the pillar with respect to the upper base using the upper positioning part and mounting the pillar on the upper base; and
positioning the pillar with respect to the lower base using the lower positioning part and mounting the pillar on the lower base.
